(19) United States
(12) Patent Application Publication
(10) Pub. No.: US 2016/0281968 A1
(43) Pub. Date: Sep. 29, 2016

(54) Lamp

(71) Applicant: Ultimate Image Corporation, Miaoli City (TW)

(72) Inventor: Chih-Feng Sung, Miaoli City (TW)

(21) Appl. No.: 14/959,767

(22) Filed: Dec. 4, 2015

(30) Foreign Application Priority Data
Mar. 24, 2015 (TW) 104109413

(51) Int. Cl. F21V 21/116; F21V 19/00; F21V 23/06; F21V 21/26; F21V 21/096

(52) U.S. Cl. CPC F21V 21/116; F21V 21/26; F21V 21/096; F21V 23/06; F21V 19/00

(57) ABSTRACT

A lamp includes a base unit, a connecting unit, a lamp unit and a fastening unit. The connecting unit includes a connecting seat connected to the base unit. The lamp unit includes a lamp housing, a light emitting member disposed in the lamp housing, a circuit module connected electrically to the light emitting member, a universal serial bus socket connected electrically to the circuit module and a power source, and a lid detachably connected to the lamp housing. The fastening unit has at least one opening formed in one of the lamp housing and the connecting seat, and at least one fastener disposed on the other one of the lamp housing and the connecting seat and engaging the opening for coupling separably the lamp unit and the connecting unit together.

### CROSS-REFERENCE TO RELATED APPLICATION

This application claims priority of Taiwanese Application No. 104109413, filed on Mar. 24, 2015.

### FIELD

The disclosure relates to a lamp that includes a base unit and a lamp unit separable from the base unit.

### BACKGROUND

A conventional lamp, such as the one disclosed in Taiwanese Utility Model Patent No. M491123, includes a base, a lamp unit and a connecting arm interconnecting the base and the lamp unit. The base includes an operation module. The lamp unit includes a lid and an LED module that is electrically connected to the operation module. The LED module can be activated by the operation module.

When repairing the lamp unit, it is laborious to remove the lamp unit from the connecting arm.

### SUMMARY

Therefore, an object of the disclosure is to provide a lamp that can alleviate the drawback associated with the conventional lamp.

According to an aspect of the present disclosure, a lamp includes a base unit, a connecting unit, a lamp unit and a fastening unit. The connecting unit includes a connecting seat that is connected to the base unit. The lamp unit includes a lamp housing, a light emitting member that is disposed in the lamp housing, a circuit module that is connected electrically to the light emitting member, a universal serial bus socket that is connected electrically to the circuit module and that is adapted to be connected electrically to a power source, and a lid that is detachably connected to the lame housing for retaining the light emitting member, the circuit module and the socket therebetween. The fastening unit has at least one opening that is formed in one of the lamp housing and the connecting seat, and at least one fastener that is disposed on the other one of the lamp housing and the connecting seat and that engages removably the at least one opening for coupling separably the lamp unit and the connecting unit together.

### BRIEF DESCRIPTION OF THE DRAWINGS

Other features and advantages of the present disclosure will become apparent in the following detailed description of the embodiments with reference to the accompanying drawings, of which:

FIG. 1 a perspective view of a first embodiment of a lamp according to the present disclosure;

FIG. 2 is another perspective view of the first embodiment;

FIG. 3 is a partly exploded perspective view of the first embodiment;

FIG. 4 is a fragmentary exploded perspective view of the first embodiment;

FIG. 5 is a fragmentary exploded perspective view of a second embodiment of the lamp according to the present disclosure;

FIG. 6 is a perspective view of a third embodiment of the lamp according to the present disclosure; and

FIG. 7 is a partly exploded perspective view of the third embodiment.

### DETAILED DESCRIPTION

Before the disclosure is described in further detail with reference to the accompanying embodiments, it should be noted herein that like elements are denoted by the same reference numerals throughout the disclosure.

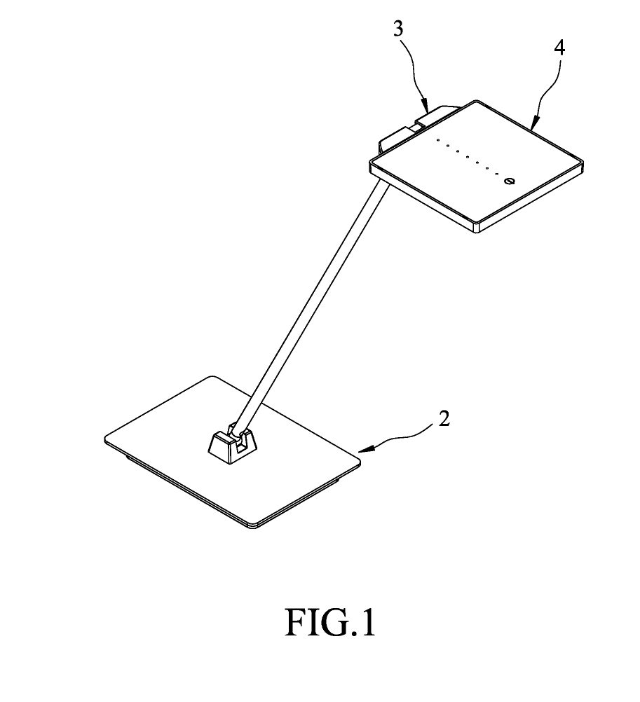

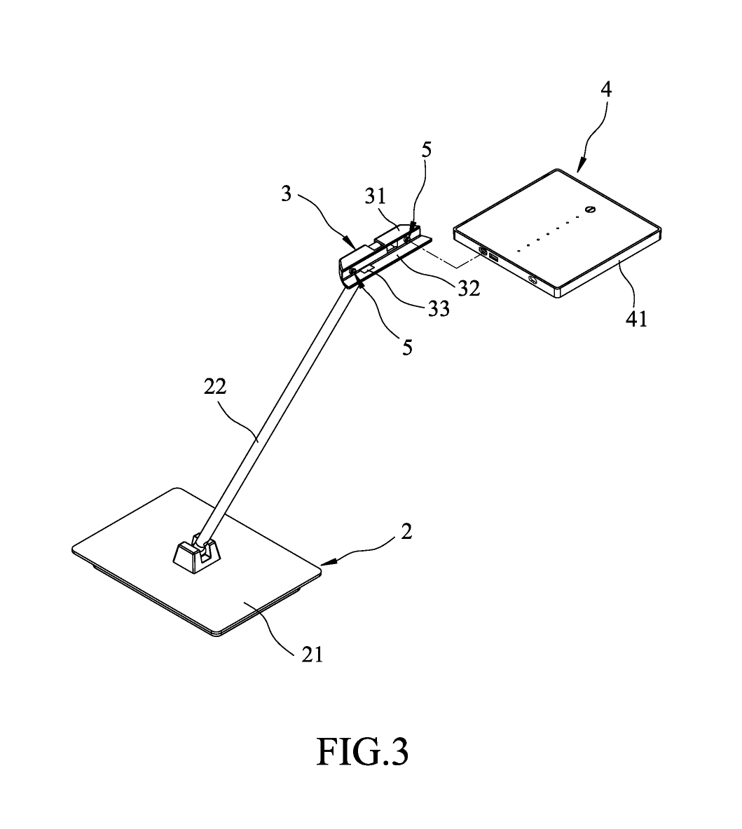

Referring to FIGS. 1 to 3, a first embodiment of the lamp according to the present disclosure includes a base unit 2, a connecting unit 3, a lamp unit 4 and a fastening unit 5.

The base unit 2 includes a base 21 and a connecting arm 22 that is connected to the base 21 and that is formed with a groove 221.

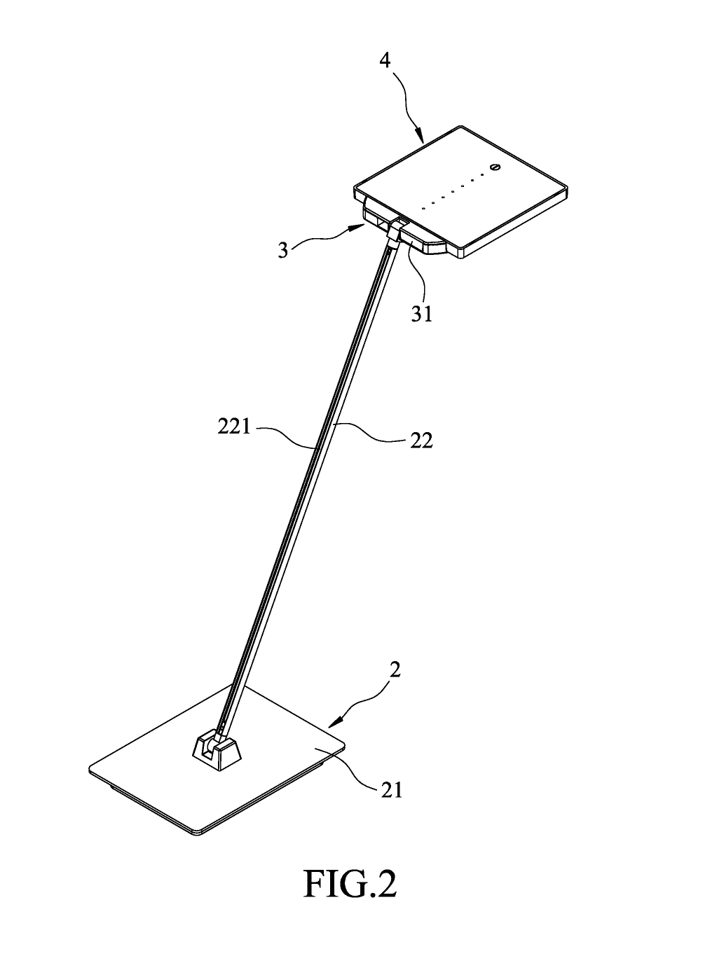

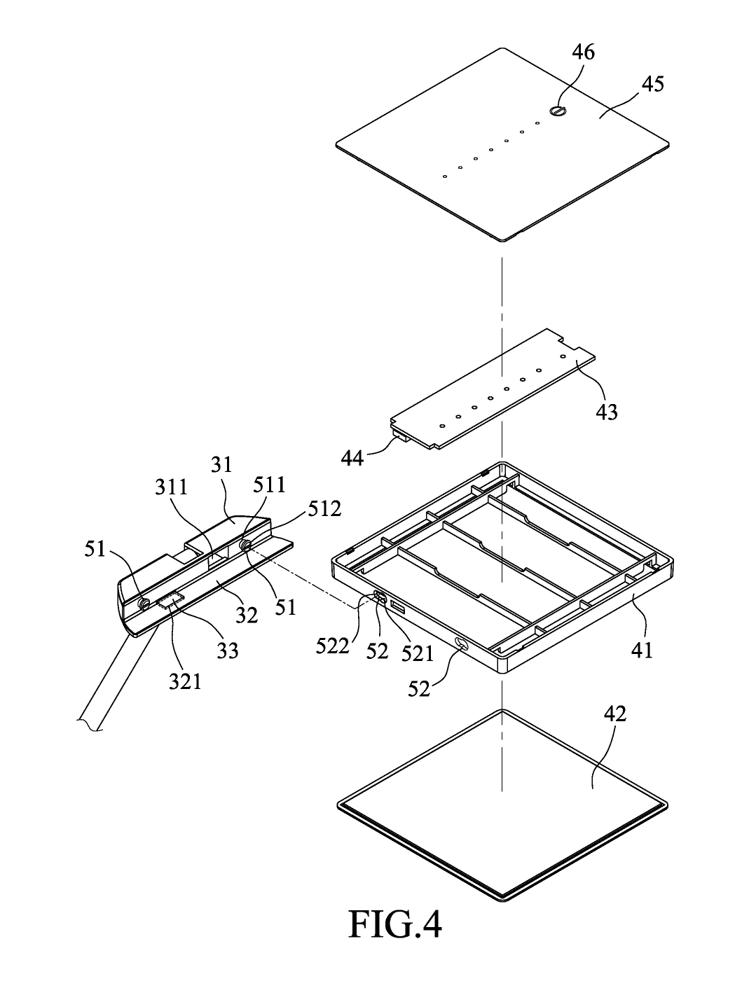

Referring to FIGS. 2 to 4, the lamp unit 4 includes a lamp housing 41 made of a magnetic metal, a light emitting member 42 disposed in the lamp housing 41, a circuit module 43 connected electrically to the light emitting member 42, a universal serial bus socket 44 connected electrically to the circuit module 43 and adapted to be connected electrically to a power source, a lid 45 detachably connected to the lamp housing 41 for retaining the light emitting member 42, the circuit module 43 and the socket 44 therebetween, and an operation module 46 disposed on the lid 45 for activating the light emitting member 42 through the circuit module 43.

In this embodiment, the connecting unit 3 includes a connecting seat 31, a support plate 32, and a bottom magnet 33. The connecting seat 31 is connected to the connecting arm 22 of the base unit 2 (i.e., the connecting arm 22 interconnects the base 21 and the connecting seat 31), and is formed with a through hole 311 adapted for extension of a cable (not shown) therethrough to interconnect electrically the universal serial bus socket 44 and the power source. To be more specific, the cable is connected electrically to the universal serial bus socket 44, extends through the through hole 311, is received in the groove 221 of the connecting arm 22 of the base unit 2, and s connected to the power source. The support plate 32 extends from the connecting seat 31 and supports separably the lamp housing 41 thereon. The support plate 32 is formed with a retaining groove 321. The bottom magnet 33 is fixed in the retaining groove 321 and attracts separably a bottom of the lamp housing 41.

The fastening unit 5 has two openings 52 that are formed in the lamp housing 41, and two fasteners 51 that are disposed on the connecting seat 31 and that respectively and removably engage the openings 52 for coupling separably the lamp unit 4 and the connecting unit 3 together. It should be noted that the numbers of the openings 52 and the fasteners 51 may be changed according to practical requirements as long as the lamp unit 4 and the connecting unit 3 can be coupled separably together. In an alternative configuration of the first embodiment, the locations of the openings 52 and the fasteners 51 are interchanged, that is, the openings 52 are formed in the connecting seat 31 and the fasteners 51 are disposed on the lamp housing 41.

Each of the fasteners 51 has a stem 511, and a head 512 coupled to the stem 511 and having a diameter that is larger than that of the stern 511. Each of the openings 52 has a first part 521 sized to permit extension of the head 512 of a respective one of the fasteners 51 therethrough, and a second part 522 connected to the first part 521 and sized to permit extension of the stem 511 of the respective one of the fasteners 51 therethrough and to capture the head 512 of the respective one of the fastener 51.

In this embodiment, the lamp housing 41 is configured as a square plate having a thickness of 8.2 millimeters. The light emitting member 42 is an organic light emitting diode (OLED) module. The operation module 46 is configured as a touch button. Electricity required by the circuit module 43 is supplied via the universal serial bus socket 44.

The lamp unit 4 can be quickly and easily assembled with or dissembled from the connecting unit 3. In assembling the lamp unit 4 with the connecting unit 3, the first parts 521 of the openings 52 are respectively registered with the heads 512 of the fasteners 51 so that the heads 512 can respectively extend through the first parts 521 of the openings 52. Then, the lamp housing 41 is moved so that the stems 511 of the fasteners 51 respectively enter the second parts 522 of the openings 52 and the heads 512 are respectively captured thereby. The bottom of the lamp housing 41 is attracted by the bottom magnet 33 such that the lamp unit 4 is separably assembled with the connecting unit 3.

When maintenance of the lamp unit 4 is required, such as in the cases of the light emitting member 42 malfunctioning or the replacing of the lamp housing 41 with different colors, the lamp housing 41 is moved reversely so that the stems 511 of the fasteners 51 are respectively positioned back at the first parts 521 of the openings 52. Then, the lamp unit 4 can be dissembled from the connecting unit 3 via removal of the fasteners 51 respectively from the first parts 521 of the openings 52.

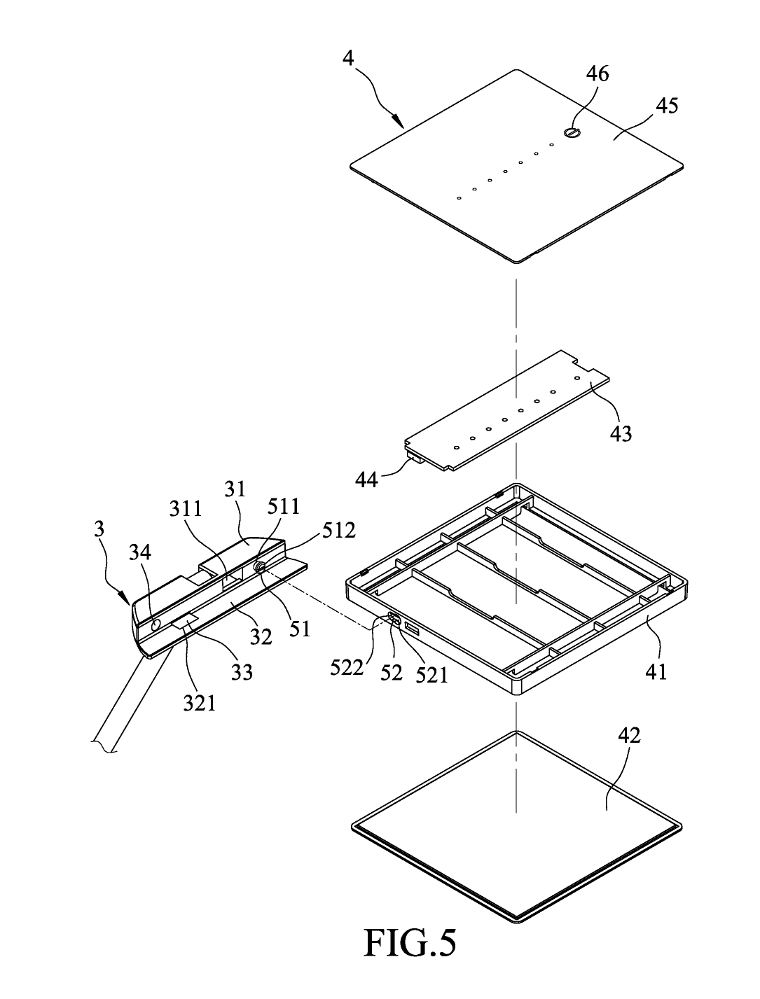

Referring to FIG. 5, a second embodiment of the lamp has a structure similar to that of the first embodiment. The difference will be described below.

In the second embodiment, the fastening unit 5 has one fastener 51 and one opening 52. The connecting unit 3 further includes a side magnet 34 that is mounted to the connecting seat 31 and that attracts separably a lateral side of the lamp housing 41. With the single fastener 51 and the single opening 52, assembling and dissembling of the lamp unit 4 with the connecting unit 3 can be accomplished faster. The bottom magnet 33 and the side magnet 34 allow the lamp unit 4 to be fixed. steadily and separably to the connecting unit 3.

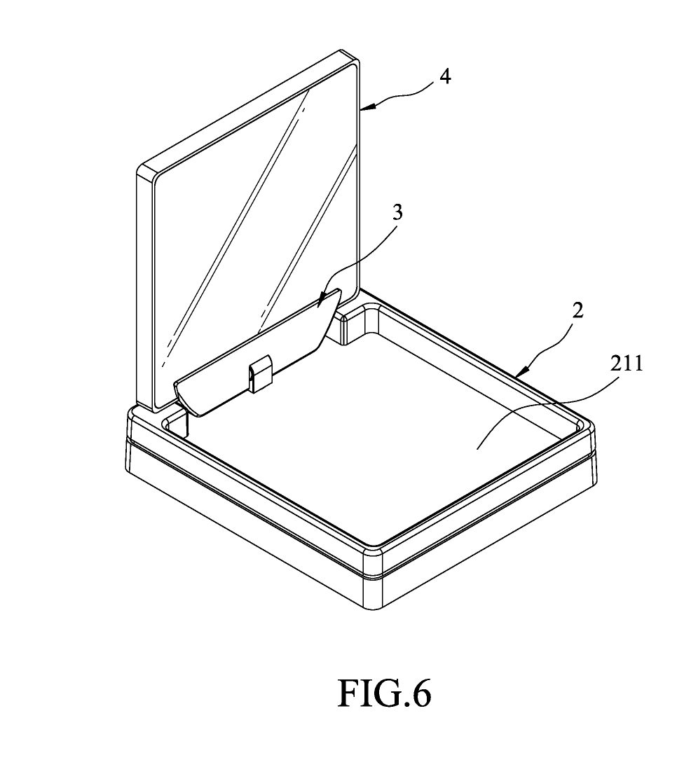

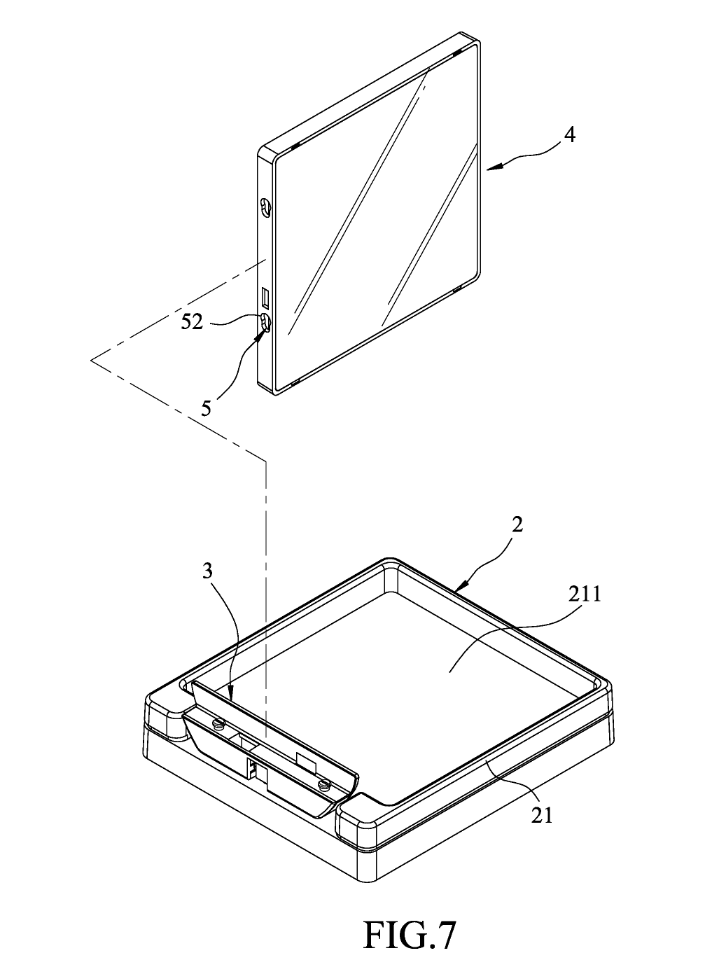

Referring to FIGS. 6 and 7, a third embodiment of the lamp has a structure similar to that of the first embodiment. The difference will be described below.

The base 21 of the base unit 2 is formed with a receiving space 211. The connecting arm 22 that is illustrated in the first embodiment is omitted. The connecting unit 3 is connected directly to the base seat 21, and is pivotable relative to the base unit 2 between a working position and a retaining position, where the lamp unit 4 is received in the receiving space 211.

To sum up, with the fastener(s) 51 and the opening(s) 52 of the fastening unit 5, the lamp unit 4 can be quickly and easily assembled with or dissembled from the connecting unit 3.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A lamp comprising:
a base unit;
a connecting unit including a connecting seat that is connected to said base unit;
a lamp unit including a lamp housing, a light emitting member that is disposed in said lamp housing, a circuit module that is connected electrically to said light emitting member, a universal serial bus socket that is connected electrically to said circuit module and that is adapted to be connected electrically to a power source, and a lid that is detachably connected to said lamp housing for retaining said light emitting member, said circuit module and said socket therebetween; and
a fastening unit having at least one opening that is formed in one of said lamp housing and said connecting seat, and at least one fastener that is disposed on the other one of said lamp housing and said connecting seat and that engages removably said at least one opening for coupling separably said lamp unit and said connecting unit together.

2. The lamp as claimed in claim 1, wherein said connecting unit further includes a support plate extending from said connecting seat and supporting separably said lamp housing thereon.

3. The lamp as claimed in claim 2, wherein:
said at least one fastener has a stem, and a head coupled to said stem and having a diameter that is larger than that of said stem; and
said at least one opening has a first part sized to permit extension of said head of said at least one fastener therethrough, and a second part connected to said first part and sized to permit extension of said stem of said at least one fastener therethrough and to capture said head of said at least one fastener.

4. The lamp as claimed in claim 3, wherein said at least one stem is disposed on said connecting seat, and said at least one opening is formed in said lamp housing.

5. The lamp as claimed, in claim 2, wherein:
said lamp housing is made of a magnetic metal;
said support plate is formed with a retaining groove; and
said connecting unit further includes a bottom magnet fixed in said retaining groove and attracting separably a bottom of said lamp housing.

6. The lamp as claimed in claim 2, wherein said connecting seat is formed with a through hole adapted for extension of a cable therethrough to interconnect electrically said universal serial bus socket and a power source.

7. The lamp as claimed in claim 2, wherein said base unit includes a base and a connecting arm interconnecting said base and said connecting seat, said connecting arm being formed with a groove that is adapted for receiving a cable which interconnects electrically said universal serial bus socket and a power source.

8. The lamp as claimed in claim 2, wherein said base unit includes a base formed with a receiving space, said connecting unit being pivotable relative to said base unit between a working position and a retracting position, where said lamp unit is received in said receiving space.

9. The lamp as claimed in claim 2, wherein
said lamp housing is made of a magnetic metal; and
said connecting unit further includes a side magnet mounted to said connecting seat and attracting separably a lateral side of said lamp housing.

10. The lamp as claimed in claim 1, wherein said lamp unit further includes an operation module disposed on said lid for activating said light emitting member.
